(19) United States
(12) Patent Application Publication
(10) Pub. No.: US 2021/0031437 A1
(43) Pub. Date: Feb. 4, 2021

(54) THREE-DIMENSIONAL MODEL AND METHOD FOR PRODUCING SAME, AND COATING AGENT FOR HYDROGEL OBJECT

(71) Applicants: Takashi MATSUMURA, Kanagawa (JP); Tatsuya NIIMI, Kanagawa (JP); Takuya SAITO, Kanagawa (JP)

(72) Inventors: Takashi MATSUMURA, Kanagawa (JP); Tatsuya NIIMI, Kanagawa (JP); Takuya SAITO, Kanagawa (JP)

(21) Appl. No.: 16/941,596

(22) Filed: Jul. 29, 2020

(30) Foreign Application Priority Data
Jul. 31, 2019 (JP) 2019-140746

(51) Int. Cl. B29C 64/124; B29C 64/209; B29C 64/245; G09B 23/30; B29C 64/188; B33Y 70/00; B33Y 80/00; B33Y 10/00; B33Y 40/20; C09D 133/26

(52) U.S. Cl. CPC B29C 64/124; B29C 64/209; B29C 64/245; G09B 23/30; B29C 64/188; B29L 2031/40; B33Y 80/00; B33Y 10/00; B33Y 40/20; C09D 133/26; B33Y 70/00

(57) ABSTRACT

Provided is a three-dimensional model including: a three-dimensional body formed of a hydrogel containing a water-based solvent and a polymer; and a coating film coating the surface of the three-dimensional body and formed of a hydrogel containing a water-based solvent and a polymer.

### CROSS-REFERENCE TO RELATED APPLICATIONS

The present application claims priority under 35 U.S.C. § 119 to Japanese Patent Application No. 2019-140746 filed Jul. 31, 2019. The contents of which are incorporated herein by reference in their entirety.

### BACKGROUND OF THE INVENTION

### Field of the Invention

The present disclosure relates to a three-dimensional mode and a method for producing a three-dimensional model, and a coating agent for a hydrogel object.

### Description of the Related Art

Methods proposed hitherto produce hydrogel three-dimensional models by mold casting using a mold that is produced with a three-dimensional (3D) printer, or produce hydrogel three-dimensional models directly with a three-dimensional printer.

In production with 3D printers, there is a problem that objects immediately after produced are roughened in the surface due to adhesion to the mold when released from the mold, or have traces of layer lamination by the 3D printers on the surface both when produced by mold casting and when produced by direct production, thus failing to have a sufficient surface smoothness.

In this regard, three-dimensional objects formed of resin-based materials, which are materially strong, can obtain surface smoothness through polishing, whereas problematically, hydrogel materials, which are soft, undergo surface structure collapse through polishing.

Hence, for example, a proposed three-dimensional model includes a hydrogel structure, and a coating film formed over the perimeter of the surface of the hydrogel structure and formed of a resin-based material (for example, see Japanese Unexamined Patent Application Publication No. 2017-26791).

### SUMMARY OF THE INVENTION

According to one aspect of the present disclosure, a three-dimensional model includes a three-dimensional body formed of a hydrogel containing a water-based solvent and a polymer, and a coating film coating the surface of the three-dimensional body and formed of a hydrogel containing a water-based solvent and a polymer.

### BRIEF DESCRIPTION OF THE DRAWINGS

FIG. 1 is an exemplary view illustrating an example of a layered clay mineral as a mineral and a state of the layered clay mineral being dispersed in water;

FIG. 2 is a schematic view illustrating an example of a liver model;

FIG. 3 is a schematic view illustrating an example of a three-dimensional model having a coating film on the surface;

FIG. 4 is a schematic view illustrating an example of a mold of a three-dimensional body used in a three-dimensional body forming step of a method for producing a three-dimensional model of the present disclosure; and

FIG. 5 is a schematic view illustrating an example of a three-dimensional object producing apparatus used in a method for producing a three-dimensional model of the present disclosure.

### DESCRIPTION OF THE EMBODIMENTS

### (Three-Dimensional Model)

A three-dimensional model of the present disclosure includes a three-dimensional body formed of a hydrogel containing a water-based solvent and a polymer, and a coating film coating the surface of the three-dimensional body and formed of a hydrogel containing a water-based solvent and a polymer, and further includes other members as needed.

The present disclosure has an object to provide a three-dimensional model that has an excellent surface smoothness and can be prevented from coating film damage during use.

The present disclosure can provide a three-dimensional model that has an excellent surface smoothness and can be prevented from coating film damage during use.

Hitherto, hydrogel three-dimensional objects have been known to get some roughness in the surface profile during object production stage, such as roughness that occurs when released from a mold in the case of mold production or traces of layer lamination structures on the side surfaces of objects in the case of three-dimensional printer production. There has been no method that can overcome such roughness. Particularly, when it comes to nanocomposite (NC) gels having a high strength and a poor followability with other resins, it has been extremely difficult to coat the gels with typical resins.

Moreover, because three-dimensional objects formed of hydrogels are structures having a high flexibility and a high deformability, such three-dimensional objects are desired to have a coating film having functions of improving appearance and smoothing the surface and having an adequate followability with deformation of the three-dimensional objects. Here, according to existing techniques, there is a problem that coating films formed of resin-based materials undergo damages such as peeling and cracking during use of the three-dimensional models, because such coating films have a poor followability and a low adhesiveness with the three-dimensional objects.

The present disclosure provides a three-dimensional body formed of a hydrogel containing a water-based solvent and a polymer, and a coating film coating the surface of the three-dimensional body and formed of a hydrogel containing a water-based solvent and a polymer, wherein the three-dimensional body and the coating film are formed of hydrogels. Therefore, it is possible to provide a three-dimensional model that can achieve both of improvement of appearance and improvement of followability, has an excellent surface smoothness, and can be prevented from coating film damage such as peeling and cracking during use.

The hydrogel constituting the three-dimensional body and the hydrogel constituting the coating film may be hydrogels of the same composition or hydrogels of different compositions. Preferably, the hydrogel constituting the three-dimensional body and the hydrogel constituting the coating film are hydrogels of different compositions.

According to one aspect of the present disclosure, it is preferable that the coating film be formed of a hydrogel formed by a mineral dispersed in a water-based solvent being combined with a polymer. A hydrogel containing a water-based solvent in a three-dimensional network structure formed by a mineral dispersed in the water-based solvent being combined with a polymer obtained through polymerization of a polymerizable monomer has a high mechanical strength and can easily form a coating film.

According to one aspect of the present disclosure, it is preferable that the tensile breaking strain of the coating film be greater than the tensile breaking strain of the three-dimensional body. With the tensile breaking strain of the coating film greater than the tensile breaking strain of the three-dimensional body, it is possible to achieve both of improvement of appearance and improvement of followability and prevent the three-dimensional model from coating film damages such as peeling and cracking during use.

Examples of the method for making the tensile breaking strain of the coating film greater than the tensile breaking strain of the three-dimensional body include a method of making the content of the water-based solvent, the mineral, or the polymerizable monomer in a hydrogel precursor liquid for the coating film higher than the content of the water-based solvent, the mineral, or the polymerizable monomer in a hydrogel precursor liquid for the three-dimensional body.

According to one aspect of the present disclosure, it is preferable that the tensile breaking strain of the coating film be 1.2 times or more greater, more preferably 1.5 times or more greater than the tensile breaking strain of the three-dimensional body. With the tensile breaking strain of the coating film greater than the tensile breaking strain of the three-dimensional body by 1.2 times or more, the coating film has an improved followability and can be better prevented from damages during use.

### <Three-Dimensional Body>

The three-dimensional body is formed of a hydrogel containing a water-based solvent and a polymer.

### <<Hydrogel>>

The hydrogel is formed of a water-based solvent and a polymer, preferably contains a mineral, and further contains other components as needed.

Examples of a preferable mode of the hydrogel include high-strength hydrogels applicable in 3D production, such as nanocomposite gels, PVA gels, and DN gels. Preferable among these hydrogels are nanocomposite gels containing water in a three-dimensional network structure formed by a mineral dispersed in water being combined with a polymer obtained through polymerization of a polymerizable monomer.

The hydrogel of the three-dimensional body has a mechanical strength, and preferably has an elasticity equivalent to a human organ when used as a human organ model. Therefore, a hydrogel having a network structure formed only of hydrogen bonds is unsuitable, but a high-strength hydrogel containing a water-based solvent, a mineral, and a polymer and having a high-density, uniform polymer-polymer crosslinkage is suitable.

Examples of high-strength hydrogels include nanocomposite (NC) gels, PVA gels, double-network gels, slide ring gels, and Tetra-PEG gels. NC gels are preferable because NC gels can be prepared through radical polymerization of a one-pack hydrogel precursor liquid, and can easily form coating films

### Water-Based Solvent

Typically, the water-based solvent is water. Examples of the water include: pure water such as ion-exchanged water, ultrafiltrated water, reverse osmotic water, and distilled water; and ultrapure water.

Examples of water-based solvents other than water include lower is alcohols such as methanol and ethanol.

Any other component such as an organic solvent may be dissolved or dispersed in the water with a view to, for example, imparting a moisture retaining property, imparting an antimicrobial activity, imparting conductivity, and adjusting hardness.

A three-dimensional model of the present disclosure contains a water-based solvent. Therefore, it is preferable to package the three-dimensional model or optionally apply a drying prevention treatment to the three-dimensional model when it is feared that the three-dimensional model may dry and undergo mechanical characteristic changes, or may become unhygienic through propagation of, for example, mildew.

### Polymer

Examples of the polymer include polymers containing, for example, an amide group, an amino group, a hydroxyl group, a tetramethylammonium group, a silanol group, and an epoxy group. The polymer is preferably water-soluble.

In the present disclosure, water-solubility of the polymer means that, for example, when 1 g of the polymer is mixed and stirred in 100 g of water having a temperature of 30 degrees C., 90% by mass or greater of the polymer dissolves.

The polymer may be a homopolymer or a heteropolymer (copolymer), may be modified, may have a known functional group introduced, or may be in the form of a salt.

The polymer is obtained from polymerization of a polymerizable monomer. A polymerizable monomer will be described in the method for producing a three-dimensional model of the present disclosure.

### Mineral

The mineral is a component contained in order to enhance the tensile breaking strain of the three-dimensional body.

The mineral is not particularly limited and may be appropriately selected depending on the intended purpose. Examples of the mineral include a layered mineral.

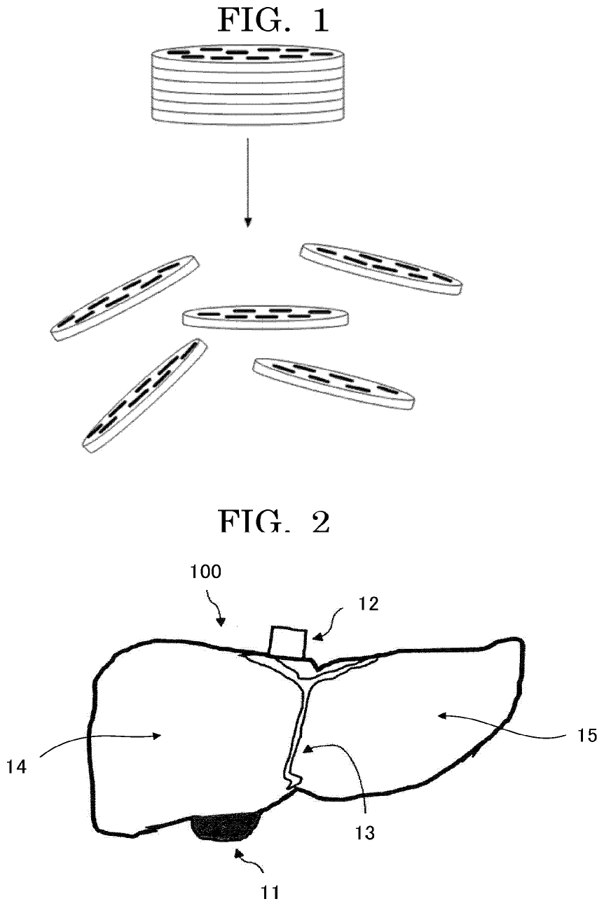

The layered mineral has a state wherein two-dimensional discoid crystals including a unit lattice in the crystals are stacked as illustrated in the upper section of FIG. 1 illustrating a state of single layers being dispersed in water. When the layered mineral is dispersed in water, the crystals are separated into single-layer forms to become discoid crystals as illustrated in the lower section of FIG. 1.

The layered mineral is not particularly limited and may be appropriately selected depending on the intended purpose. Examples of the layered mineral include a layered clay mineral.

The layered clay mineral is a layered clay mineral dispersible uniformly in water at the primary crystal level. Examples of the layered clay mineral include water-swellable smectite and water-swellable mica. More specific examples of the layered clay mineral include water-swellable hectorite containing sodium as an interlayer ion, water-swellable montmorillonite, water-swellable saponite, and water-swellable synthetic mica. One of these layered clay minerals may be used alone or two or more of these layered clay minerals may be used in combination. The layered clay mineral may be an appropriately synthesized product or a commercially available product.

Examples of the commercially available product include synthetic hectorite (LAPONITE XLG, available from Rock Wood), SWN (available from Coop Chemical Ltd.), and fluorinated hectorite SWF (available from Coop Chemical Ltd.). Among these commercially available products, synthetic hectorite is preferable in terms of elastic modulus.

Water-swellability means that a layered clay mineral is dispersed in water when water molecules are inserted between single layers of the layered clay mineral as illustrated in FIG. 1.

The content of the mineral is preferably 1% by mass or greater but 40% by mass or less and more preferably 1% by mass or greater but 25% by mass or less relative to the total amount of the three-dimensional body.

### Other Components

The other components are not particularly limited and may be appropriately selected depending on the intended purpose. Examples of the other components include an organic solvent, an antiseptic, a colorant, a fragrance, an antioxidant, a stabilizing agent, and a viscosity modifier.

The organic solvent is contained in order to enhance the moisture retaining property of the hydrogel.

Examples of the organic solvent include: alkyl alcohols containing 1 through 4 carbon atoms, such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones or ketone alcohols such as acetone, methyl ethyl ketone, and diacetone alcohol; ethers such as tetrahydrofuran and dioxane; polyvalent alcohols such as ethylene glycol, propylene glycol, 1,2-propanediol, 1,2-butanediol, 1,3-butanediol, 1,4-butanediol, diethylene glycol, triethylene glycol, 1,2,6-hexanetriol, thioglycol, hexylene glycol, and glycerin; polyalkylene glycols such as polyethylene glycol and polypropylene glycol; lower alcohol ethers of polyvalent alcohols such as ethylene glycol monomethyl (or ethyl) ether, diethylene glycol methyl (or ethyl) ether, triethylene glycol monomethyl (or ethyl) ether; alkanolamines such as monoethanolamine, diethanolamine, and triethanolamine; N-methyl-2-pyrrolidone; 2-pyrrolidone; and 1,3-dimethyl-2-imidazolidinone. One of these organic solvents may be used alone or two or more of these organic solvents may be used in combination. Among these organic solvents, polyvalent alcohols are referable in terms of a moisture retaining property, and glycerin and propylene glycol are more preferable.

The content of the organic solvent is preferably 10% by mass or greater but 50% by mass or less relative to the total amount of the three-dimensional body. When the content of the organic solvent is 10% by mass or greater, a sufficient drying preventing effect can be obtained. When the content of the organic solvent is 50% by mass or less, the layered clay mineral is dispersed uniformly.

### Antiseptic

Examples of the antiseptic include dehydroacetates, sorbates, benzoates, pentachlorophenol sodium, 2-pyridinethiol-1-oxide sodium, 2,4-dimethyl-6-acetoxy-m-dioxane, and 1,2-benzthiazolin-3-one.

### Colorant

The colorant is not particularly limited and may be appropriately selected depending on the intended purpose. Examples of the colorant include dyes and pigments.

Specific examples of the dyes and pigments include dyes and pigments described in Japanese Unexamined Patent Application Publication No. 2017-26791.

The three-dimensional body is a main structural part of the three-dimensional model. The three-dimensional body may have various shapes depending on the applications of the three-dimensional model.

The tensile breaking strain of the three-dimensional body is preferably 200% or greater and more preferably 230% or greater. When the tensile breaking strain of the three-dimensional body is 200% or greater, the three-dimensional body has a desired shape and a desired strength.

The tensile breaking strain is obtained as a coefficient of elongation (%) at break, measured by testing a tensile test piece with a tensile tester (AG-10KNX, available from Shimadzu Corporation) at a tensile speed of 500 mm/min according to JIS K6251, where the tensile test piece is produced to have a shape of a dumbbell No. 3 having a thickness of 5 mm, using a hydrogel precursor liquid for the three-dimensional body used for producing the three-dimensional body.

The rubber hardness of the three-dimensional body is preferably 6 or greater but 60 or less and more preferably 8 or greater but 20 or less.

When the rubber hardness is less than 6, shape collapse may occur during production. When the rubber hardness is greater than 60, cracking may occur during releasing or detachment after production.

The rubber hardness can be measured using, for example, a durometer (available from Teclock, GS-718N).

The three-dimensional body may have an inclusion (internal structure) varied in at least any one selected from color and hardness at an intended position. Hence, the three-dimensional body can also be used as a human organ model such as an organ model for pre-surgery confirmation of the position to which a surgical scalpel is inserted.

Examples of the inclusion include: mimics of blood vessels, vessels, and diseased parts; cavities; and creases.

The color can be adjusted by, for example, adding a colorant in the hydrogel precursor liquid for the three-dimensional body. Using the colorant, it is possible to color the three-dimensional body in, for example, a color approximated to a human organ of a human body.

The tensile breaking strain or the hardness can be adjusted by, for example, changing the contents of the layered clay mineral and the polymerizable monomer in the hydrogel precursor liquid for the three-dimensional body.

### <Coating Film>

The coating film coats the surface of the three-dimensional boy, and is formed of a hydrogel containing a water-based solvent and a polymer.

The hydrogel is formed of a water-based solvent and a polymer, preferably contains a mineral, and further contains other components as needed.

As the water-based solvent, the polymer, the mineral, and the other components, the same materials as used in the three-dimensional body can be used.

The hydrogel constituting the coating film and the hydrogel constituting the three-dimensional body may be hydrogels of the same composition or hydrogels of different compositions. Preferably, the hydrogel constituting the three-dimensional body and the hydrogel constituting the coating film are hydrogels of different compositions.

The tensile breaking strain of the coating film is not particularly limited so long as the tensile breaking strain of the coating film is greater than the tensile breaking strain of the three-dimensional body, and is preferably 300% or greater and more preferably 350% or greater. When the tensile breaking strain of the coating film is 300% or greater, the coating film has a good followability and can be prevented from being damaged during use.

The tensile breaking strain of the coating film can be measured in the same manner as measuring the tensile breaking strain of the three-dimensional body, using a hydrogel precursor liquid for the coating film.

The average thickness of the coating film is preferably 1 micrometer or greater but 2,000 micrometers or less, more preferably 1 micrometer or greater but 1,000 micrometers or less, and yet more preferably 100 micrometers or greater but 800 micrometers or less.

The average thickness of the coating film can be obtained by forming a film of the hydrogel precursor liquid for the coating film over a glass by, for example, dip coating, curing the film, partially peeling the film, and measuring the partially peeled, stepped portions with a laser microscope. The average thickness is the average of ten positions.

The breaking strain is varied between the materials of the hydrogel precursor liquid for the coating film and the materials of the hydrogel precursor liquid for the internal three-dimensional body, and the coating film and the three-dimensional body have a difference in Young's modulus. Therefore, in order to distinguish or identify the coating film, for example, a probe-type elasticity meter such as “SOFT MEASURE” available from Horiuchi Electronics Co., Ltd. may be used. This makes it possible to confirm the difference between the Young's modulus of the coating film containing the hydrogel precursor liquid for the coating film and the Young's modulus of the three-dimensional body, which is an internal structure, and distinguish the coating film. Alternatively, because the coating film and the three-dimensional body have a frictional resistance difference, the coating film can be distinguished by measurement of the frictional resistance.

### (Method for Producing Three-Dimensional Model)

A method for producing a three-dimensional model of the present disclosure includes a three-dimensional body forming step and a coating film forming step, and further includes other steps as needed.

### <Three-Dimensional Body Forming Step>

The three-dimensional body forming step is a step of forming a three-dimensional body using a hydrogel precursor liquid for the three-dimensional body containing a polymerizable monomer and a water-based solvent.

### <<Hydrogel Precursor Liquid for Three-Dimensional Body>>

The hydrogel precursor liquid for the three-dimensional body contains a polymerizable monomer and a water-based solvent, preferably contains a mineral, and further contains other components as needed.

As the water-based solvent, the mineral, and the other components, the same materials as used in the three-dimensional body described above can be used.

### Polymerizable Monomer

The polymerizable monomer is a monomer that is polymerized to become the polymer constituting the three-dimensional body.

Examples of the polymerizable monomer include acrylamide, N-substituted acrylamide derivatives, N,N-disubstituted acrylamide derivatives, N-substituted methacrylamide derivatives, and N,N-disubstituted methacrylamide derivatives. One of these polymerizable monomers may be used alone or two or more of these polymerizable monomers may be used in combination.

Specific examples of the polymerizable monomer include acrylamide, N,N-dimethylacrylamide (DMAA), and N-isopropylacrylamide.

As the polymerizable monomer, other monofunctional monomers and multifunctional monomers may be used as needed.

The content of the polymerizable monomer is not particularly limited, may be appropriately selected depending on the intended purpose, and is preferably 0.5% by mass or greater but 20% by mass or less and more preferably 1% by mass or greater but 10% by mass or less relative to the total amount of the hydrogel precursor liquid for the three-dimensional body.

It is preferable to polymerize the hydrogel precursor liquid for the three-dimensional body using a polymerization initiator. The polymerization initiator is used, with the polymerization initiator added in the hydrogel precursor liquid for the three-dimensional body.

### Polymerization Initiator

Examples of the polymerization initiator include a thermal polymerization initiator and a photopolymerization initiator.

The thermal polymerization initiator is not particularly limited and may be appropriately selected depending on the intended purpose. Examples of the thermal polymerization initiator include azo-based initiators, peroxide initiators, persulfate initiators, and redox (oxidoreduction) initiators.

Examples of the azo-based initiators include: VA-044, VA-46B, V-50, VA-057, VA-061, VA-067, VA-086, 2,2′-azobis(4-methoxy-2,4-dimethylvaleronitrile) (VAZO 33), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64), 2,2′-azobis-2-methylbutyronitrile (VAZO 67), and 1,1-azobis(1-cyclohexanecarbonitrile) (VAZO 88) (all available from Du Pont Chemicals Ltd.); and 2,2′-azobis(2-cyclopropylpropionitrile), and 2,2′-azobis(methylisobutyrate) (V-601) (available from Wako Pure Chemical Industries, Ltd.).

Examples of the peroxide initiators include benzoyl peroxide, acetyl peroxide, lauroyl peroxide, decanoyl peroxide, dicetyl peroxydicarbonate, di(4-t-butylcyclohexyl)peroxydicarbonate (PERKADOX 16S) (available from Akzo Nobel), di(2-ethylhexyl)peroxydicarbonate, t-butylperoxy pivalate (LUPERSOL 11) (available from Elf Atochem), t-butylperoxy-2-ethyl hexanoate (TRIGONOX 21-C50) (available from Akzo Nobel), and dicumyl peroxide.

Examples of the persulfate initiators include potassium persulfate, sodium persulfate, ammonium persulfate, and sodium peroxodisulfate.

Examples of the redox (oxidoreduction) initiators include combination of a persulfate initiator with a reducing agent such as sodium hydrogen metasulfite or sodium hydrogen sulfite, a system based on an organic peroxide and a tertiary amine (for example, a system based on benzoyl peroxide and dimethyl aniline), and a system based on an organic hydroperoxide and a transition metal (for example, a system based on cumen hydroperoxide and cobalt naphthenate).

As the photopolymerization initiator, any substance that produces radicals in response to irradiation with light (particularly, ultraviolet rays having a wavelength of from 220 nm through 400 nm) can be used.

Examples of the photopolymerization initiator include acetophenone, 2,2-diethoxyacetophenone, p-dimethylaminoacetophenone, benzophenone, 2-chlorobenzophenone, p,p′-dicyclobenzophenone, p,p-bisdiethylaminobenzophenone, Michler's ketone, benzyl, benzoin, benzoin methylether, benzoin ethylether, benzoin isopropylether, benzoin-n-propylether, benzoin isobutylether, benzoin-n-butylether, benzyl methyl ketal, thioxanthone, 2-chlorothioxanthone, 2-hydroxy-2-methyl-1-phenyl-1-one, 1-(4-isopropylphenyl)2-hydroxy-2-methylpropan-1-one, methyl benzoyl formate, 1-hydroxycyclohexylphenyl ketone, azobis isobutyronitrile, benzoyl peroxide, and di-tert-butyl peroxide. One of these photopolymerization initiators may be used alone or two or more of these photopolymerization initiators may be used in combination.

Tetramethylethylene diamine is used as an initiator of a polymerization/gelation reaction for transforming acrylamide to polyacrylamide gel.

The three-dimensional body forming step is not particularly limited and may be appropriately selected depending on the intended purpose. Generally, the three-dimensional body needs to reproduce a complicated shape, and may mixedly include a plurality of portions having different properties. Hence, the three-dimensional body may be produced according to the method described below.

According to one aspect, the three-dimensional body is produced by, for example, producing a mold according to an appropriate producing method such as a three-dimensional (3D) printer, injecting the hydrogel precursor liquid for the three-dimensional body into the mold, and curing the hydrogel precursor liquid for the three-dimensional body. An inclusion such as a blood vessel may be formed separately and located at a predetermined position in the mold. It is preferable to produce the mold and the inclusion such as a blood vessel by cutting, stereolithography, or 3D printer production of metals or resins.

According to another aspect, for the three-dimensional body, a method of laminating layers of the hydrogel precursor liquid for the three-dimensional body, and as needed, layers of a support liquid using a 3D printer may be employed.

More specifically, in terms of accurate shaping, it is preferable to produce the three-dimensional body by discharging the hydrogel precursor liquid for the three-dimensional body using a material jet object producing apparatus employing an inkjet method.

The support liquid is a liquid used for producing a support at the same time as producing the three-dimensional body using a three-dimensional printer, in order to support the structure produced and realize stable object production. The support is removed after the object being produced is completed. Examples of the material of the support include polyester, polyolefin, polyethylene terephthalate, PPS, polypropylene, PVA, polyethylene, polyvinyl chloride, cellophane, acetate, polystyrene, polycarbonate, nylon, polyimide, fluororesin, paraffin wax, acrylic resins, and epoxy resins.

An example of production of the three-dimensional body using a 3D printer will be described below in detail.

### [Object Producing Method Using a 3D Printer]

First, the hydrogel precursor liquid for the three-dimensional body is applied to an intended position with an appropriate accuracy. Here, the applying method is not particularly limited and may be appropriately selected depending on the intended purpose so long as the applying method can apply the hydrogel precursor liquid for the three-dimensional body. Examples of the applying method include a dispenser method, a spray method, and an inkjet method. Known apparatuses may be suitably used for carrying out these methods. The applying method is carried out repeatedly. The number of times to repeat varies depending on, for example, the size, shape, and structure of the three-dimensional object to be produced, and cannot be determined flatly. So long as the thickness per layer is within the range of 10 micrometers or greater but 50 micrometers or less, an object can be successfully produced accurately without peeling or detachment. Therefore, there is a need for repeating laminating layers by the height of the three-dimensional object to be produced.

Among the applying methods, the dispenser method has excellent liquid droplet quantitativity, but has a small coating coverage. The spray method can form a minute jet of the materials easily and has a wide coating coverage and excellent coatability, but has a poor liquid droplet quantitativity and causes scattering due to a spray current. Hence, in the present disclosure, the inkjet method is particularly preferable. The inkjet method is preferable because the inkjet method is better than the spray method in liquid droplet quantitativity, can obtain a greater coating coverage than can be obtained by the dispenser method, and can form a complicated three-dimensional shape with a good accuracy efficiently.

Next, the film formed above is cured.

Examples of the method for curing the film include an ultraviolet (UV) irradiation lamp, and an electron beam. It is preferable that the unit configured to cure the film be provided with a mechanism configured to remove ozone.

Examples of the kind of the ultraviolet (UV) irradiation lamp include a high-pressure mercury lamp, an ultrahigh-pressure mercury lamp, a metal halide, and a LED lamp.

The ultrahigh-pressure mercury lamp is a point light source. A Deep UV type combined with an optical system for enhancement of the light utilization efficiency can emit short wavelength ranges.

The metal halide having a wide wavelength range is effective for colored articles. Halides of metals such as Pb, Sn, and Fe are used, and may be appropriately selected depending on the absorption spectrum of a photopolymerization initiator. The lamp used for curing is not particularly limited and may be appropriately selected depending on the intended purpose. For example, commercially available lamps such as H LAMP, D LAMP, or V LAMP available from Fusion Systems Japan Co., Ltd. may be used. By the method described above, the three-dimensional body is produced.

### <Coating Film Forming Step>

The coating film forming step is a step of applying a hydrogel precursor liquid for a coating film containing a polymerizable monomer and a water-based solvent to the three-dimensional body to form a coating film.

### <<Hydrogel Precursor Liquid for Coating Film>>

The hydrogel precursor liquid for the coating film has the same basic composition as the hydrogel precursor liquid for the three-dimensional body used for producing the three-dimensional body. Hence, the hydrogel of the three-dimensional body and the hydrogel of the coating film constituting a three-dimensional model may be hydrogels of the same composition or hydrogels of different compositions. Preferably, the hydrogel of the three-dimensional body and the hydrogel of the coating film are hydrogels of different compositions, because the properties needed in the three-dimensional body and the properties needed in the coating film are often different. Hence, hydrogels having respective desired properties can be obtained.

The viscosity of the hydrogel precursor liquid for the coating film is preferably 30 mPa·s or lower, and more preferably 20 mPa·s or lower at 25 degrees C. When the viscosity is 30 mPa·s or lower at 25 degrees C., the surface smoothness is improved, and a coating film having an appropriate thickness can be formed. The coating film can follow deformation of the three-dimensional body, and can be prevented from being damaged.

By repeating applying the hydrogel precursor liquid for the coating film having a low viscosity of 10 mPa·s or lower a plurality of times, it is possible to better improve the surface smoothness and form a coating film that stores the structure of the three-dimensional body.

The method for forming the coating film is not particularly limited and may be appropriately selected depending on the intended purpose, so long as the method can apply the hydrogel precursor liquid for the coating film over the surface of the three-dimensional body. Examples of the method include dip coating, brush coating, and spraying.

A coating film formed of a hydrogel is formed through polymerization and curing of the hydrogel precursor liquid for the coating film applied.

Examples of the method for polymerizing the hydrogel precursor liquid for the coating film include thermal polymerization and photopolymerization.

In the case of thermal polymerization, the temperature may be adjusted to any temperature at which a polymerization reaction can be promoted. At a higher temperature, a coating film can be formed at a higher speed.

In the case of photopolymerization, a coating film can be formed through application of the hydrogel precursor liquid for the coating film and irradiation of the hydrogel precursor liquid for the coating film with a lamp having a reactive wavelength.

### <Other Steps>

The other steps are not particularly limited and may be appropriately selected depending on the intended purpose. Examples of the other steps include a washing step.

The three-dimensional model of the present disclosure with the three-dimensional body and the coating film formed of hydrogels can achieve both of improvement of appearance and improvement of followability, has an excellent surface smoothness, and can be prevented from coating film damage such as peeling and cracking during use. Therefore, the three-dimensional model of the present disclosure can be widely used in various technical fields, and is suitably used as a human organ model described below.

### <Human Organ Model>

A human organ model, which is the three-dimensional model of the present disclosure, includes a three-dimensional body (main body) formed of a water-based solvent and a polymer, and preferably, a mineral, and a coating film provided over the surface of the three-dimensional body.

When used as the human organ model, the three-dimensional model can faithfully reproduce an internal structure such as a blood vessel and a diseased part, gives impressions extremely close to impressions given by a desired human organ when touched or cut, and can be incised with a surgical scalpel. Therefore, the human organ model is suitable, for example, as a human organ model for medical procedures training for doctors, medical interns, and medical students at, for example, doctors, medical departments of universities, and hospitals, as a human organ model for surgical scalpel cutting edge testing, used for pre-shipment testing of the cutting edge of surgical scalpels produced, and as a human organ model for pre-surgery confirmation of the cutting edge of surgical scalpels.

When the three-dimensional model of the present disclosure is used as a human organ model, a coating film structure that mimics a biological membrane present over the surface of a human organ may further be formed. This enables, for example, reproduction of peeling of a biological membrane in medical procedures, and reproduction of impressions felt by operating medical devices such as surgical scalpels. For such biological membranes, resin forming paints or hydrogel forming paints adjusted to physical properties suited to biological tissues can be used. The coating film of the three-dimensional model of the present disclosure may be used as the coating film structure.

The human organ to which the human organ model is applicable is not particularly limited, and any organs in a human body may be reproduced. Examples of the human organ include: organs such as brain, heart, esophagus, stomach, bladder, small intestine, large intestine, liver, kidney, pancreas, spleen, and uterus; body surface tissue such as skin; and sensory organs such as eyeball.

The following description will be given based on a liver model, which is the three-dimensional body of the three-dimensional model illustrated in FIG. 2.

The liver is the largest organ in the human body present at the right-hand side of the upper abdomen and below the rib. An adult liver weighs from 1.2 kg through 1.5 kg. The liver plays important roles such as transforming nutrients taken in from foods to forms that can be utilized by the body, “metabolism” of storing and supplying the nutrients, “detoxification” of detoxifying toxic substances, and secretion of bile for assisting decomposition and absorption of, for example, fats.

As illustrated in FIG. 2, the liver model 100 is fixed on the anterior abdominal wall by the falciform ligament of liver 13, and divided into the right lobe 14 and the left lobe 15 by the Cantlie line that couples the gall bladder 11 to the inferior vena cava 12.

A surgical operation for cutting out part of the liver is the hepatectomy. Most of the indications of the hepatectomy are liver cancers (primary hepatic cancer), and in addition, metastatic liver cancer, benign hepatic tumor, and hepatic trauma.

Depending on the cutting manner, the hepatectomy is classified into, for example, partial excision, subsegmentectomy, segmentectomy, lobectomy, extended lobectomy, and trisegmentectomy. The liver has no marks that indicate these segments. Therefore, for surgical operations, the boundaries are distinguished based on changes of color through tying the portal vein or the hepatic artery that nourishes the segment concerned or injecting a pigment to the blood vessels. The liver is then excised using various devices such as electric scalpels, harmonic scalpels (ultrasonic vibration surgical instruments), CUSA (Cavitron ultrasonic surgical aspirator), and Microtase (microwave surgical instrument).

For simulation of the surgical operation, a human organ model that can faithfully reproduce an inclusion such as a blood vessel and a diseased part, gives impressions extremely close to impressions given by a desired human organ when touched or cut, and can be incised with a surgical scalpel can be used suitably.

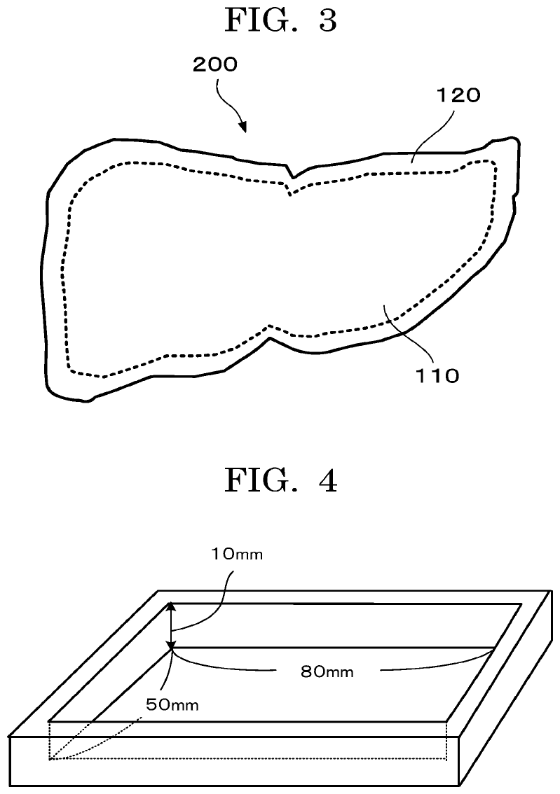

FIG. 3 is a schematic view illustrating an example of the three-dimensional model having a coating film over the surface. This three-dimensional model 200 includes a three-dimensional body 110, and a coating film 120 formed over the surface of the three-dimensional body. This three-dimensional model, which includes the three-dimensional body and the coating film formed of hydrogels, can achieve both of improvement of appearance and improvement of followability, has an excellent surface smoothness, and can be prevented from coating film damage such as peeling and cracking during use. Therefore, the three-dimensional model is suitable as a human organ model for medical procedures training.

### (Coating Agent for Hydrogel Object)

Hitherto, it has been difficult to apply to hydrogel three-dimensional objects, post-production finishing for overcoming roughness in the surface profile generated in the production stage, for improvement of appearance. However, the present inventors have found it possible to achieve fine finishing of hydrogel three-dimensional objects, by coating the surface of the hydrogel three-dimensional objects with a coating agent for a hydrogel object to form coating films formed of hydrogels.

The coating agent for a hydrogel object of the present disclosure contains a hydrogel precursor liquid containing a polymerizable monomer, a water-based solvent, and preferably, a mineral.

The hydrogel precursor liquid contained in the coating agent for a hydrogel object of the present disclosure is the same as the hydrogel precursor liquid for the coating film described above.

### EXAMPLES

The present disclosure will be described below by way of Examples. The present disclosure should not be construed as being limited to these Examples.

### Example 1

### <Preparation of Hydrogel Precursor Liquid for Three-Dimensional Body>

In the following description, ion-exchanged water degassed at reduced pressure for 10 minutes is described as “pure water”.

First, an aqueous solution of 1-hydroxycyclohexylphenyl ketone [product name: IRGACURE 184] (obtained from BASF Japan Ltd.) (2 parts by mass) in pure water (98 parts by mass) was prepared as an initiator liquid.

Next, to pure water (195 parts by mass) under stirring, synthetic hectorite having the composition of [Mg_{5.34}Li_{0.66}Si₈O₂₀(OH)₄]Na._{0.66} (LAPONITE XLG, obtained from Rock Wood) (8 parts by mass) was added little by little as a layered clay mineral. The resultant was stirred, to produce a dispersion liquid.

Next, to the dispersion liquid, N,N-dimethylacrylamide (obtained from Wako Pure Chemical Industries, Ltd.) (20 parts by mass) passed through an activated alumina column for removal of a polymerization inhibitor was added as a polymerizable monomer.

Next, sodium dodecyl sulfate (obtained from Wako Pure Chemical Industries, Ltd.) (0.2 parts by mass) was added as a surfactant and mixed.

Next, the initiator liquid (5 parts by mass) was added, and stirred and mixed. Subsequently, the resultant was degassed at reduced pressure for 10 minutes, to obtain a homogeneous hydrogel precursor liquid for the three-dimensional body.

### <Production of Three-Dimensional Body>

Using a FDM-type 3D printer (obtained from UPRINT SE PLUS, obtained from Stratasys Japan Co., Ltd.), the mold illustrated in FIG. 4 was produced with polylactic acid (PLA). The hydrogel precursor liquid for the three-dimensional body was poured into the mold, and irradiated and cured with UV light for 5 minutes using HANDICURE 100 (obtained from Mizuka Planning), to obtain a three-dimensional body having a size of 50 mm in depth, 80 mm in width, and 10 mm in thickness.

### <Measurement of Tensile Breaking Strain of Three-Dimensional Body>

The hydrogel precursor liquid for the three-dimensional body was poured into a mold having a shape of a dumbbell No. 3 having a thickness of 5 mm (compliant with JIS K6251), and irradiated and cured with UV light for 5 minutes using HANDICURE 100 (obtained from Mizuka Planning), to produce a tensile test piece. This tensile test piece was tested with a tensile tester (AG-10KNX, obtained from Shimadzu Corporation) at a tensile speed of 500 mm/min according to JIS K6251. As a result, the tensile breaking strain (coefficient of elongation (%) at break) was 230%.

Next, a coating film was formed over the surface of the three-dimensional body obtained above, in a manner described below.

### <Preparation of Hydrogel Precursor Liquid 1 for Coating Film>

First, pure water (60 parts by mass) was added in a precursor liquid (40 parts by mass) prepared in the same manner as the hydrogel precursor liquid for the three-dimensional body described above, to dilute the precursor liquid (to a ratio by mass of 40% with the pure water), to prepare a hydrogel precursor liquid 1 for the coating film.

### <Formation of Coating Film>

The produced three-dimensional body was set on a dip coater (DT-0303-S4, obtained from SDI), to be dipped in the hydrogel precursor liquid 1 for the coating film. Subsequently, the three-dimensional body was lifted up at a lifting speed of 0.5 mm/sec, and irradiated and cured with UV light for 5 minutes using HANDICURE 100 (obtained from Mizuka Planning), to form a coating film having an average thickness of 300 micrometers over the surface of the three-dimensional body.

To obtain the average thickness of the coating film, the hydrogel precursor liquid 1 for the coating film was coated over a glass slide prepared for coating film measurement in the same manner as coating the hydrogel precursor liquid 1 for the coating film over the three-dimensional body described above, and subsequently cured, to form a film. The central portion of the film was partially peeled, and a cross-section of the peeled portion was measured with a laser microscope at predetermined intervals, to obtain ten measurements, which were averaged as the average of the coating film thickness.

### <Measurement of Tensile Breaking Strain of Coating Film>

The hydrogel precursor liquid for the coating film was poured into a mold having a shape of a dumbbell No. 3 having a thickness of 5 mm (compliant with JIS K6251), and irradiated and cured with UV light for 5 minutes using HANDICURE 100, to produce a tensile test piece. This tensile test piece was tested with a tensile tester (AG-10KNX, obtained from Shimadzu Corporation) at a tensile speed of 500 mm/min according to JIS K6251. As a result, the tensile breaking strain (coefficient of elongation (%) at break) was 380%.

### Example 2

A three-dimensional model of Example 2 was obtained in the same manner as in Example 1, except that unlike in Example 1, formation of the coating film was repeated three times.

The average thickness of the coating film of Example 2 measured in the same manner as in Example 1 was 800 micrometers.

### Example 3

A three-dimensional model of Example 3 was obtained in the same manner as in Example 1, except that unlike in Example 1, formation of the coating film was repeated six times.

The average thickness of the coating film of Example 3 measured in the same manner as in Example 1 was 1,600 micrometers.

### Example 4

A three-dimensional model of Example 4 was obtained in the same manner as in Example 1, except that unlike in Example 1, the coating film was formed entirely by brush coating.

The average thickness of the coating film of Example 4 measured in the same manner as in Example 1 was 400 micrometers.

### Example 5

A three-dimensional model of Example 5 was obtained in the same manner as in Example 1, except that unlike in Example 1, production of the three-dimensional body was changed as described below.

### Production of Three-Dimensional Body

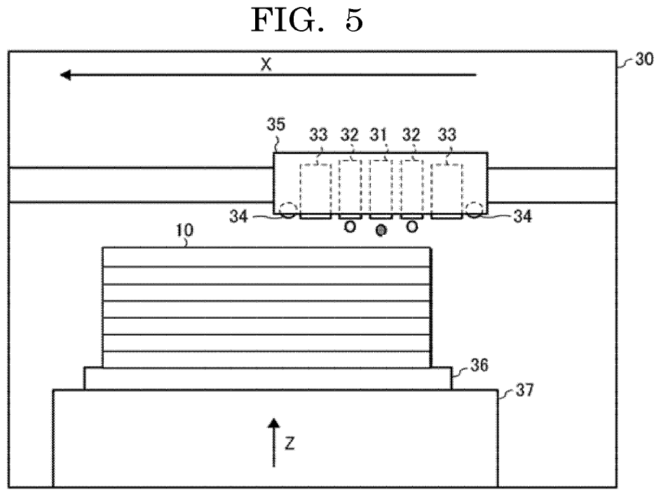

From a discharging head unit 31 for the three-dimensional body of a three-dimensional body producing apparatus 30 illustrated in FIG. 5, the hydrogel precursor liquid for the three-dimensional body was discharged to an area having a size of 50 mm in depth and 80 mm in width over a stage 37, to form a liquid film 10. In FIG. 5, the reference numeral 32 denotes discharging head units for a support, and the reference numeral 36 denotes a supporting substrate.

Using SPOT CURE SP5-250DB (obtained from Ushio Inc.) as ultraviolet irradiators 33, the liquid film was irradiated and cured with a light volume of 350 mJ/cm². Subsequently, the layer, which was the cured film, was smoothed with rollers 34. As the rollers 34, metallic rollers formed of an aluminum alloy surface-treated by alumiting and having a diameter of 25 mm were used. The discharging process and the curing process described above were repeated, to laminate smoothed layers as ink-jetted films by the thickness of 10 mm, to obtain a three-dimensional body having a size of 50 mm in depth, 80 mm in width, and 10 mm in thickness.

### Example 6

A three-dimensional model of Example 6 was obtained in the same manner as in Example 1, except that unlike in Example 1, the content of the polymerizable monomer of the hydrogel precursor liquid for the three-dimensional body was changed to 30 parts by mass, and the content of the synthetic hectorite was changed to 10 parts by mass.

The average thickness of the coating film of Example 6 measured in the same manner as in Example 1 was 300 micrometers.

### Example 7

A three-dimensional model of Example 7 was obtained in the same manner as in Example 6, except that the hydrogel precursor liquid for the coating film prepared in the preparation of the hydrogel precursor liquid for the coating film in Example 6 was diluted with pure water to a ratio by mass of 40%. The average thickness of the coating film of Example 7 measured in the same manner as in Example 1 was 300 micrometers.

### Comparative Example 1

A three-dimensional model of Comparative Example 1 was obtained in the same manner as in Example 1, except that unlike in Example 1, no coating film was formed over the surface of the three-dimensional body.

### Comparative Example 2

A three-dimensional model of Comparative Example 2 was obtained in the same manner as in Example 1, except that unlike in Example 1, a coating film was formed using the hydrogel precursor liquid for the three-dimensional body instead of the hydrogel precursor liquid 1 for the coating film.

The average thickness of the coating film of Comparative Example 2 measured in the same manner as in Example 1 was 800 micrometers.

### Comparative Example 3

A three-dimensional model of Comparative Example 3 was obtained in the same manner as in Example 1, except that unlike in Example 1, the hydrogel precursor liquid 1 for the coating film was changed to a hydrogel precursor liquid 2 for the coating film prepared in the manner described below.

The average thickness of the coating film of Comparative Example 3 measured in the same manner as in Example 1 was 800 micrometers.

### <Preparation of Hydrogel Precursor Liquid 2 for Coating Film>

The hydrogel precursor liquid 2 for the coating film was prepared in the same manner as preparing the hydrogel precursor liquid for the three-dimensional body, except that unlike in the preparation of the hydrogel precursor liquid for the three-dimensional body of Example 1, the content of the synthetic hectorite (LAPONITE XLG, obtained from Rock) was changed from 8 parts by mass to 16 parts by mass, and the content of N,N-dimethylacrylamide was changed from 20 parts by mass to 30 parts by mass.

### <Measurement of Tensile Breaking Strain of Coating Film>

The tensile breaking strain (coefficient of elongation (%) at break) of the coating film of Comparative Example 3 measured in the same manner as measuring the tensile breaking strain of the coating film of Example 1 was 150%.

The surface roughness Ra and the bending resistance test of the three-dimensional models obtained in Examples 1 to 7 and Comparative Examples 1 to 3 were measured or performed in the manners described below. The results are presented in Table 1 and Table 2.

### <Evaluation of Surface Roughness>

An image of the surface profile of each three-dimensional model was captured with a laser microscope (VK-1000, obtained from Keyence Corporation), to measure the surface roughness Ra.

### <Bending Resistance Test>

A jig for a three-point bending test for plastics was attached to a universal tester (AGS-2N, obtained from Shimadzu Corporation), an operation of indenting by 20 mm and returning was repeated five times, and subsequently the surface condition of each three-dimensional model was observed, to evaluate presence or absence of damage (peeling, cracking) of the coating film.

TABLE 1

| | | Ex. | | | | | | |
|---|---|---|---|---|---|---|---|---|
| | | 1 | 2 | 3 | 4 | 5 | 6 | 7 |
| Method for forming | | Mold | Mold | Mold | Mold | 3D | Mold | Mold |
| three-dimensional body | | | | | | production | | |
| Hydrogel precursor liquid | | 1 | 1 | 1 | 1 | 1 | 1 | 1 |
| for coating film No. | | | | | | | | |
| Method for forming coating film | | DIP: | DIP: 3 | DIP: 6 | Brush | DIP: | DIP: | DIP |
| | | once | times | times | coating | once | once | once |
| Average thickness | | 300 | 800 | 1,600 | 400 | 300 | 300 | 300 |
| of coating film (micrometer) | | | | | | | | |
| Tensile | Three-dimensional | 230 | 230 | 230 | 230 | 230 | 180 | 180 |
| breaking | body | | | | | | | |
| strain (%) | Coating film | 380 | 380 | 380 | 380 | 380 | 380 | 270 |

| | | | | | | | |
|---|---|---|---|---|---|---|---|
| Surface roughness Ra (micrometer) | 28 | 17 | 8 | 30 | 13 | 28 | 21 |
| Surface condition after bending | No | No | No | No | No | No | No |
| resistance test | change | change | change | change | change | change | change |

*In any of Examples 1 to 7, the tensile breaking strain of the coating film was 1.65 times greater than the tensile breaking strain of the three-dimensional body.

TABLE 2

| | | Comp. Ex. | | |
|---|---|---|---|---|
| | | 1 | 2 | 3 |
| Method for forming | | Mold | Mold | Mold |
| three-dimensional body | | | | |
| Hydrogel precursor liquid | | None | Hydrogel precursor | 2 |
| for coating film No. | | | liquid for three- | |
| | | | dimensional body | |
| Method for forming | | None | DIP: once | DIP: once |
| coating film | | | | |
| Average thickness of coating | | — | 800 | 800 |
| film (micrometer) | | | | |
| Tensile | Three- | 230 | 230 | 230 |
| breaking | dimensional | | | |
| strain (%) | body | | | |
| | Coating film | — | 230 | 150 |

| | | | |
|---|---|---|---|
| Surface roughness | 42 | 20 | 22 |
| Ra (micrometer) | | | |
| Surface condition after | No | Cracked | Torn |
| bending resistance test | change | | |

*In Comparative Example 2, the tensile breaking strain of the coating film was 1 time greater than the tensile breaking strain of the three-dimensional body.
*In Comparative Example 3, the tensile breaking strain of the coating film was 0.65 times greater than the tensile breaking strain of the three-dimensional body.

From the results of Table 1 and Table 2, it was revealed that Examples 1 to 7 in which a coating film was present over the surface of the three-dimensional body resulted in smaller surface roughness Ra and better surface smoothness than Comparative Example 1 in which there was no coating film over the surface.

Comparative Examples 2 and 3 in which the tensile breaking strain of the coating film was equivalent to or lower than the tensile breaking strain of the three-dimensional body resulted in cracking or tearing. This is considered due to that the coating film, which was a thin film, was unable to endure deformation of the three-dimensional body to end up being damaged.

Examples 1 to 7 in which the tensile breaking strain of the coating film was greater than the tensile breaking strain of the three-dimensional body turned out to have no damage in the coating film because the coating film was able to sufficiently follow deformation of the three-dimensional body.

Aspects of the present disclosure are, for example, as follows.
<1> A three-dimensional model including:

a three-dimensional body formed of a hydrogel containing a water-based solvent and a polymer; and

a coating film coating the surface of the three-dimensional body, the coating film being formed of a hydrogel containing a water-based solvent and a polymer.
<2> The three-dimensional model according to <1>,

wherein the coating film is formed of the hydrogel, which is formed of a mineral dispersed in the water-based solvent and the polymer, the mineral being combined with the polymer.
<3> The three-dimensional model according to <1> or <2>,

wherein a tensile breaking strain of the coating film is greater than a tensile breaking strain of the three-dimensional body.
<4> The three-dimensional model according to <3>,

wherein the tensile breaking strain of the coating film is 300% or greater.
<5> The three-dimensional model according to <3> or <4>,

wherein the tensile breaking strain of the coating film is 1.5 times or more greater than the tensile breaking strain of the three-dimensional body.
<6> The three-dimensional model according to any one of <1> to <5>,

wherein the three-dimensional model is a human organ model.
<7> The three-dimensional model according to any one of <1> to <5>,

wherein the three-dimensional model is used as a human organ model for medical procedures training.
<8> A three-dimensional model including:

a three-dimensional body formed of a hydrogel containing a water-based solvent and a polymer; and

a coating film coating the surface of the three-dimensional body,

wherein a tensile breaking strain of the coating film is greater than a tensile breaking strain of the three-dimensional body.
<9> A method for producing a three-dimensional model, the method including:

forming a three-dimensional body using a hydrogel precursor liquid for a three-dimensional body, the hydrogel precursor liquid containing a polymerizable monomer and a water-based solvent; and

applying a hydrogel precursor liquid for a coating film to the three-dimensional body to form a coating film, the hydrogel precursor liquid containing a polymerizable monomer and a water-based solvent.
<10> The method for producing a three-dimensional model according to <9>,

wherein the hydrogel precursor liquid for the three-dimensional body contains the polymerizable monomer, the water-based solvent, and a mineral.
<11> The method for producing a three-dimensional model according to <9> or <10>,

wherein the hydrogel precursor liquid for the coating film contains the polymerizable monomer, the water-based solvent, and a mineral.
<12> The method for producing a three-dimensional model according to any one of <9> to <11>,

wherein in the forming the three-dimensional body, the three-dimensional body is formed using a three-dimensional printer.
<13> The method for producing a three-dimensional model according to any one of <9> to <11>,

wherein in the forming the three-dimensional body, the three-dimensional body is formed by injecting the hydrogel precursor liquid for the three-dimensional body into a mold and subsequently curing the hydrogel precursor liquid for the three-dimensional body.
<14> The method for producing a three-dimensional model according to any one of <9> to <13>,

wherein the coating film is formed by dip coating, brush coating, or spraying of the hydrogel precursor liquid for the coating film.
<15> A coating agent for a hydrogel object, the coating agent including:

a hydrogel precursor liquid containing a polymerizable monomer and a water-based solvent.

The three-dimensional model according to any one of <1> to <8>, the method for producing a three-dimensional model according to any one of <9> to <14>, and the coating agent for a hydrogel object according to <15> can solvent the various problems in the related art and achieve the object of the present disclosure.

What is claimed is:

1. A three-dimensional model comprising:
a three-dimensional body formed of a hydrogel containing a water-based solvent and a polymer; and
a coating film coating a surface of the three-dimensional body, the coating film being formed of a hydrogel containing a water-based solvent and a polymer.

2. The three-dimensional model according to claim 1,
wherein the coating film is formed of the hydrogel, which is formed of a mineral dispersed in the water-based solvent and the polymer, the mineral being combined with the polymer.

3. The three-dimensional model according to claim 1,
wherein a tensile breaking strain of the coating film is greater than a tensile breaking strain of the three-dimensional body.

4. The three-dimensional model according to claim 3,
wherein the tensile breaking strain of the coating film is 1.2 times or more greater than the tensile breaking strain of the three-dimensional body.

5. The three-dimensional model according to claim 1,
wherein the three-dimensional model is a human organ model.

6. A method for producing a three-dimensional model, the method comprising:
forming a three-dimensional body using a hydrogel precursor liquid for a three-dimensional body, the hydrogel precursor liquid containing a polymerizable monomer and a water-based solvent; and
applying a hydrogel precursor liquid for a coating film to the three-dimensional body to form a coating film, the hydrogel precursor liquid containing a polymerizable monomer and a water-based solvent.

7. The method for producing a three-dimensional model according to claim 6,
wherein in the forming the three-dimensional body, the three-dimensional body is formed using a three-dimensional printer.

8. The method for producing a three-dimensional model according to claim 6,
wherein in the forming the three-dimensional body, the three-dimensional body is formed by injecting the hydrogel precursor liquid for the three-dimensional body into a mold and subsequently curing the hydrogel precursor liquid for the three-dimensional body.

9. The method for producing a three-dimensional model according to claim 6,
wherein the coating film is formed by dip coating, brush coating, or spraying of the hydrogel precursor liquid for the coating film.

10. A coating agent for a hydrogel object, the coating agent comprising:
a hydrogel precursor liquid containing a polymerizable monomer and a water-based solvent.
